(19) United States
(12) Patent Application Publication
(10) Pub. No.: US 2025/0303984 A1
(43) Pub. Date: Oct. 2, 2025

(54) RELAY CONTROL DEVICE, CONTROL SYSTEM, CONTROL METHOD, AND COMPUTER PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP); TOYOTA JIDOSHA KABUSHIKI KAISHA, Toyota-Shi, Aichi (JP)

(72) Inventors: Darmawan GO, Yokkaichi-Shi, Mie (JP); Tomohiro OTSU, Yokkaichi-Shi, Mie (JP); Kentaro ASHIBE, Yokkaichi-Shi, Mie (JP); Hirofumi URAYAMA, Yokkaichi-Shi, Mie (JP); Makoto CHUJO, Osaka-Shi, Osaka (JP); Ikuyoshi OTAKE, Toyota-Shi, Aichi (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP); Toyota Jidosha Kabushiki Kaisha, Toyota-Shi, Aichi-Ken (JP)

(21) Appl. No.: 18/863,583

(22) PCT Filed: May 8, 2023
(86) PCT No.: PCT/JP2023/017321

§ 371 Date: Nov. 6, 2024

(30) Foreign Application Priority Data
May 23, 2022 (JP) 2022-083648

(51) Int. Cl. B60R 16/023; B60R 16/03

(52) U.S. Cl. CPC B60R 16/023; B60R 16/03

(57) ABSTRACT

A relay control device includes a control unit for switching a plurality of relay circuits connected to a plurality of ECUs, between a relay-on state and a relay-off state, the plurality of ECUs include a first ECU having a transition function of causing its own operating state to transition between at least two of a normal state, a sleep state, and a power-off state in accordance with a power supply state of the vehicle, and a second ECU not having the transition function, and the control unit executes switching control of switching a second relay circuit connected to the second ECU to the relay-off state while maintaining a first relay circuit connected to the first ECU in the relay-on state, when switching the second ECU from the relay-on state to the relay-off state due to a change in the power supply state.

### CROSS REFERENCE TO RELATED APPLICATIONS

This application is the U.S. National Stage of PCT/JP2023/017321 filed on May 8, 2023, which claims priority of Japanese Patent Application No. JP 2022-083648 filed on May 23, 2022.

### TECHNICAL FIELD

The present disclosure relates to a relay control device, a control system, a control method, and a computer program.

### BACKGROUND

A relay control device for supplying and interrupting power to an ECU (Electronic Control Unit), an actuator, or the like installed in a vehicle has been known.

For example, Japanese Laid-Open Patent Publication No. 2018-053979 discloses a technology in which a relay control device performs a process of turning off a relay device when an ignition switch is operated from ON to OFF.

Some ECUs have a function of causing their own operating state to transition in accordance with the state of an ignition switch (transition function). As for such an ECU, for example, the ECU wakes itself up when the ignition switch is operated from OFF to ON, and the ECU goes to sleep when the ignition switch is operated from ON to OFF.

In the case where a relay control device supplies and interrupts power to an ECU having a transition function, if the relay control device interrupts power to the ECU while the ECU is causing its own operating state to transition, a defect may occur in the ECU.

In view of the above problem, an object of the present disclosure is to provide a relay control device, a control system, a control method, and a computer program that can suppress occurrence of a defect in an ECU for which supply and interruption of power is controlled by the relay control device.

### SUMMARY

A relay control device of the present disclosure is a relay control device installed in a vehicle, wherein: the relay control device includes a control unit configured to switch each of a plurality of relay circuits respectively connected to a plurality of ECUs, between a relay-on state where power is supplied to the ECU and a relay-off state where no power is supplied to the ECU; the plurality of ECUs include a first ECU having a transition function of causing its own operating state to transition between at least two of a normal state, a sleep state, and a power-off state in accordance with a power supply state of the vehicle, and a second ECU not having the transition function; and the control unit executes switching control of switching a second relay circuit connected to the second ECU among the plurality of relay circuits to the relay-off state while maintaining a first relay circuit connected to the first ECU among the plurality of relay circuits in the relay-on state, when switching the second ECU from the relay-on state to the relay-off state due to a change in the power supply state if each of the plurality of relay circuits is in the relay-on state.

A control method of the present disclosure is a control method for controlling a plurality of relay circuits respectively connected to a plurality of ECUs, by a relay control device installed in a vehicle, wherein: the plurality of ECUs include a first ECU having a transition function of causing its own operating state to transition between at least two of a normal state, a sleep state, and a power-off state in accordance with a power supply state of the vehicle, and a second ECU not having the transition function; the control method includes a switching step of switching each of the plurality of relay circuits between a relay-on state where power is supplied to the ECU and a relay-off state where no power is supplied to the ECU; and the switching step includes a step of switching a second relay circuit connected to the second ECU among the plurality of relay circuits to the relay-off state while maintaining a first relay circuit connected to the first ECU among the plurality of relay circuits in the relay-on state, when switching the second ECU from the relay-on state to the relay-off state due to a change in the power supply state if each of the plurality of relay circuits is in the relay-on state.

A computer program of the present disclosure is a computer program for controlling a plurality of relay circuits respectively connected to a plurality of ECUs, by a relay control device installed in a vehicle, wherein: the plurality of ECUs include a first ECU having a transition function of causing its own operating state to transition between at least two of a normal state, a sleep state, and a power-off state in accordance with a power supply state of the vehicle, and a second ECU not having the transition function; the computer program causes a computer to execute a switching step of switching each of the plurality of relay circuits between a relay-on state where power is supplied to the ECU and a relay-off state where no power is supplied to the ECU; and the switching step includes a step of switching a second relay circuit connected to the second ECU among the plurality of relay circuits to the relay-off state while maintaining a first relay circuit connected to the first ECU among the plurality of relay circuits in the relay-on state, when switching the second ECU from the relay-on state to the relay-off state due to a change in the power supply state if each of the plurality of relay circuits is in the relay-on state.

According to the present disclosure, it is possible to suppress occurrence of a defect in the ECU for which supply and interruption of power is controlled by the relay control device.

Embodiments of the present disclosure include the following configurations as a gist thereof.

### BRIEF DESCRIPTION OF DRAWINGS

FIG. 1 shows an example of a control system according to an embodiment.

FIG. 2 illustrates a problem addressed by the embodiment.

FIG. 3 is a flowchart showing an example of a control method according to the embodiment.

FIG. 4 is a flowchart showing a control method according to a modification.

FIG. 5 shows a control system according to a modification.

FIG. 6 shows a control system according to a modification.

FIG. 7 is a flowchart showing a control method according to the modification.

### DETAILED DESCRIPTION OF PREFERRED EMBODIMENTS

In a first aspect, a relay control device of the present disclosure is a relay control device installed in a vehicle, wherein: the relay control device includes a control unit configured to switch each of a plurality of relay circuits respectively connected to a plurality of ECUs, between a relay-on state where power is supplied to the ECU and a relay-off state where no power is supplied to the ECU; the plurality of ECUs include a first ECU having a transition function of causing its own operating state to transition between at least two of a normal state, a sleep state, and a power-off state in accordance with a power supply state of the vehicle, and a second ECU not having the transition function; and the control unit executes switching control of switching a second relay circuit connected to the second ECU among the plurality of relay circuits to the relay-off state while maintaining a first relay circuit connected to the first ECU among the plurality of relay circuits in the relay-on state, when switching the second ECU from the relay-on state to the relay-off state due to a change in the power supply state if each of the plurality of relay circuits is in the relay-on state.

With such a configuration, the supply of power to the first ECU is maintained after the switching control, so that forcible interruption of the supply of power in the middle of the first ECU causing its operating state to transition can be avoided. Accordingly, occurrence of a defect in the first ECU can be suppressed.

In a second aspect, if the first relay circuit is in the relay-on state, the first ECU may transmit predetermined information indicating that the first ECU has the transition function, to the relay control device, and the control unit may execute the switching control based on the predetermined information.

The relay control device may have the predetermined information, and the control unit may execute the switching control based on this information.

With such a configuration, the control unit can grasp the first relay circuit connected to the first ECU, based on the predetermined information.

In a third aspect, the relay control device according to the second aspect above, the control unit may maintain the first relay circuit in the relay-on state if the relay control device receives a communication message for detecting communication with the first ECU, at an interval within a predetermined time after the switching control is executed, and may switch the first relay circuit to the relay-off state if the relay control device does not receive the communication message for more than the predetermined time after the switching control is executed.

Accordingly, the first relay circuit can be brought into the relay-off state while occurrence of a defect in the first ECU is suppressed, so that the power consumption in the control system can be reduced.

In a fourth aspect, the relay control device according to the second aspect or according to the third aspect above, the predetermined information may include information requesting notification of the power supply state to the first ECU. Accordingly, the control load in the control system can be reduced.

In a fifth aspect, the relay control device according to the second aspect to the fourth aspect above, based on the predetermined information, the control unit may determine the first ECU from among the plurality of ECUs or may determine the first relay circuit from among the plurality of relay circuits.

In a sixth aspect, the relay control device according to the first aspect to the fifth aspect above may be connected to a relay circuit provided outside the relay control device among the plurality of relay circuits, directly by a power line, or via another device.

In a seventh aspect, the relay control device according to the first aspect to the sixth aspect above, at least one of the plurality of relay circuits may be provided inside the relay control device.

In an eighth aspect, a control system of the present disclosure is a control system including: the relay control device according to the first aspect to the seventh aspect above; a plurality of the ECUs including the first ECU; and a plurality of the relay circuits including the first relay circuit.

In a ninth aspect, a control method of the present disclosure is a control method for controlling a plurality of relay circuits respectively connected to a plurality of ECUs, by a relay control device installed in a vehicle, wherein: the plurality of ECUs include a first ECU having a transition function of causing its own operating state to transition between at least two of a normal state, a sleep state, and a power-off state in accordance with a power supply state of the vehicle, and a second ECU not having the transition function; the control method includes a switching step of switching each of the plurality of relay circuits between a relay-on state where power is supplied to the ECU and a relay-off state where no power is supplied to the ECU; and the switching step includes a step of switching a second relay circuit connected to the second ECU among the plurality of relay circuits to the relay-off state while maintaining a first relay circuit connected to the first ECU among the plurality of relay circuits in the relay-on state, when switching the second ECU from the relay-on state to the relay-off state due to a change in the power supply state if each of the plurality of relay circuits is in the relay-on state.

With such a configuration, the supply of power to the first ECU is maintained after the step of switching the second relay circuit which is the relay circuit other than the first relay circuit to the relay-off state, so that forcible interruption of the supply of power in the middle of the first ECU causing its operating state to transition can be avoided. Accordingly, occurrence of a defect in the first ECU can be suppressed.

In a tenth aspect, a computer program of the present disclosure is a computer program for controlling a plurality of relay circuits respectively connected to a plurality of ECUs, by a relay control device installed in a vehicle, wherein: the plurality of ECUs include a first ECU having a transition function of causing its own operating state to transition between at least two of a normal state, a sleep state, and a power-off state in accordance with a power supply state of the vehicle, and a second ECU not having the transition function; the computer program causes a computer to execute a switching step of switching each of the plurality of relay circuits between a relay-on state where power is supplied to the ECU and a relay-off state where no power is supplied to the ECU; and the switching step includes a step of switching a second relay circuit connected to the second ECU among the plurality of relay circuits to the relay-off state while maintaining a first relay circuit connected to the first ECU among the plurality of relay circuits in the relay-on state, when switching the second ECU from the relay-on state to the relay-off state due to a change in the power supply state if each of the plurality of relay circuits is in the relay-on state.

With such a configuration, the supply of power to the first ECU is maintained after the step of switching the second relay circuit which is the relay circuit other than the first relay circuit to the relay-off state, so that forcible interruption of the supply of power in the middle of the first ECU causing its operating state to transition can be avoided. Accordingly, occurrence of a defect in the first ECU can be suppressed.

Hereinafter, details of an embodiment of the present disclosure will be described with reference to the drawings.

### Configuration of Control System

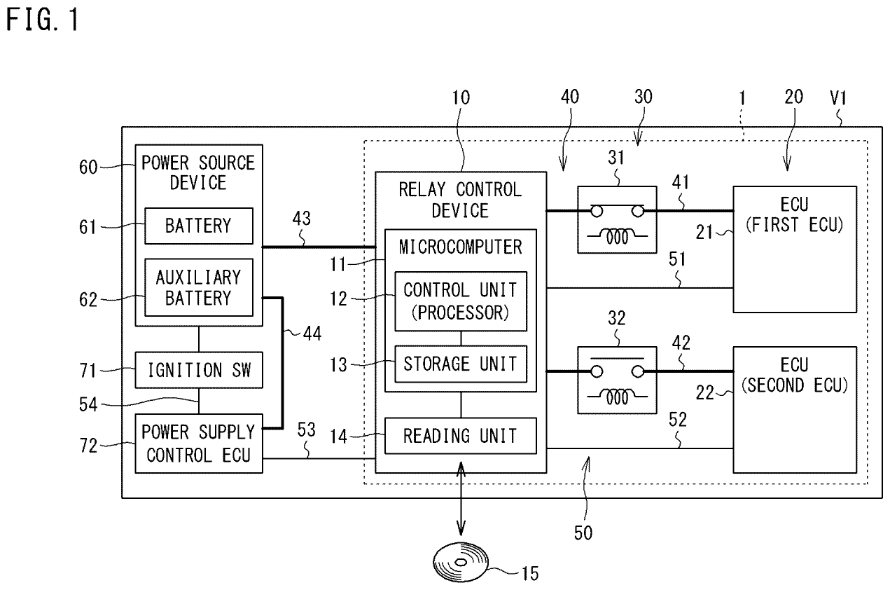

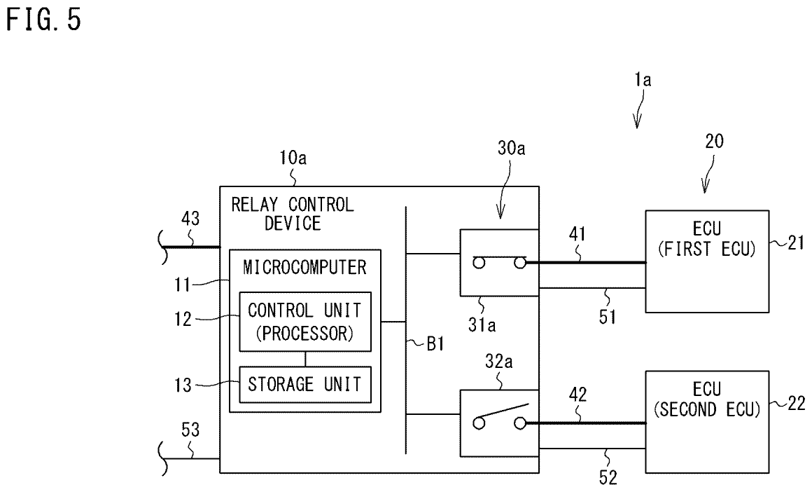

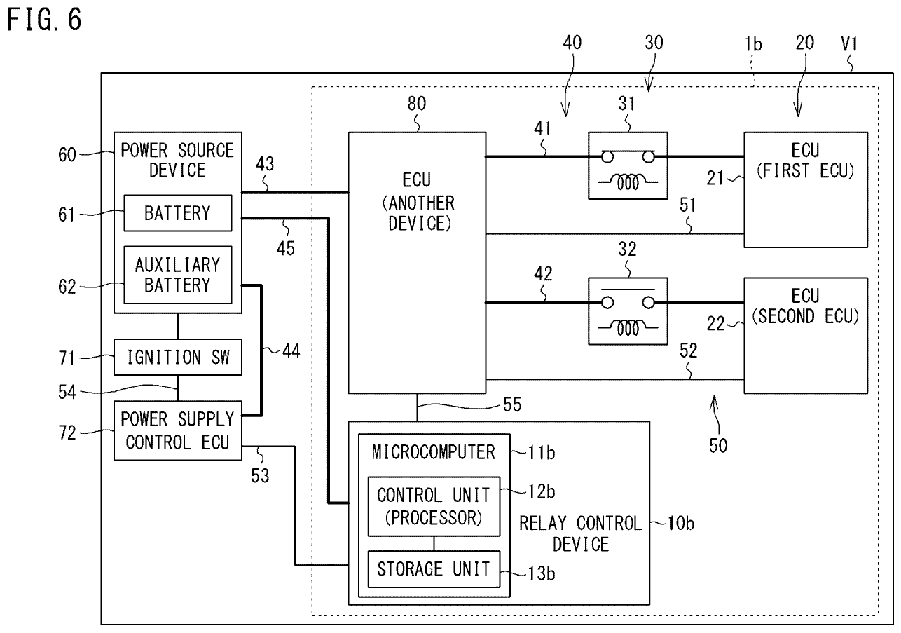

FIG. 1 shows a configuration example of a control system 1 according to the embodiment. In FIG. 1, the thin lines connecting various parts of the control system 1 mean communication lines, and the thick lines connecting various parts of the control system 1 mean power lines. The same applies to subsequent configuration examples (FIG. 5 and FIG. 6).

The control system 1 is a system installed in a vehicle V1 such as an automobile. The control system 1 includes a relay control device 10, a plurality of ECUs (Electronic Control Units) 20, a plurality of relay circuits 30, a plurality of power lines 40, and a plurality of communication lines 50. A power source device 60, an ignition switch 71, and a power supply control ECU 72 are further installed in the vehicle V1.

The power source device 60 is a device that supplies power to various parts of the vehicle V1. The power source device 60 includes a battery 61 used during normal operation, and an auxiliary battery 62 used in an auxiliary manner when the power of the battery 61 is insufficient. The auxiliary battery 62 is, for example, an uninterruptible power supply (UPS). The ignition switch 71 is a switch that switches the power supply state of the vehicle V1, for example, by an occupant of the vehicle V1 inserting a key thereinto and rotating the key. The ignition switch 71 may be operated by an occupant of the vehicle V1 carrying an electronic key and pressing the switch without inserting the key. The ignition switch 71 switches the power supply state of the vehicle V1 between a vehicle power-off state, an accessory ON state (ACC ON state), an ignition ON state (IG ON state), and an engine start state each time operation is performed.

In the vehicle power-off state, the ACC ON state, and the IG ON state, the range of power supplied from the power source device 60 to various parts of the vehicle V1 is wider in this order. The vehicle power-off state is, for example, a state where no power is supplied from the power source device 60 to various parts of the vehicle V1, including accessory electrical equipment described below, except for constant power supply. The ACC ON state is, for example, a state where power is supplied from the power source device 60 to the accessory electrical equipment (e.g., an audio device, a navigation device, etc.) installed in the vehicle V1 and no power is supplied to the other parts. The IG ON state is, for example, a state where power is supplied from the power source device 60 to each part of the vehicle V1 except a cell motor (starter). The engine start state is, for example, a state where power is supplied from the power source device 60 to the cell motor.

The power supply control ECU 72 is connected to the ignition switch 71 via a communication line 54. The power supply control ECU 72 acquires information regarding the power supply state of the vehicle V1 (power supply information D1) based on a signal transmitted from the ignition switch 71 via the communication line 54. The power supply control ECU 72 transmits the power supply information D1 to the relay control device 10 via a communication line 53.

The relay control device 10 is a device that controls each of the plurality of relay circuits 30. The relay control device 10 includes a microcomputer 11 including a control unit 12 and a storage unit 13, and a reading unit 14.

The control unit 12 includes a circuit configuration (circuitry) such as a processor, for example. Specifically, the control unit 12 includes one or more CPUs (Central Processing Units). The processor included in the control unit 12 may be a GPU (Graphics Processing Unit). In this case, the control unit 12 reads a computer program stored in the storage unit 13 and executes various calculations and controls.

The control unit 12 may include a processor in which a predetermined program is written in advance. For example, the control unit 12 may be an integrated circuit such as a CPLD (Complex Programmable Logic Device), an FPGA (Field-Programmable Gate Array), or an ASIC (Application Specific Integrated Circuit). In this case, the control unit 12 executes various calculations and controls based on the program written in advance.

The storage unit 13 has a volatile memory and a nonvolatile memory and stores various data therein. The volatile memory includes, for example, a RAM (Random Access Memory). The nonvolatile memory includes, for example, a flash memory, an HDD (Hard Disk Drive), an SSD (Solid State Drive), a ROM (Read Only Memory), or the like. The storage unit 13 stores, for example, a computer program and various parameters in the nonvolatile memory.

The reading unit 14 reads information from a computer-readable recording medium 15. The recording medium 15 is, for example, an optical disk such as a CD or DVD or a USB flash memory. The reading unit 14 is, for example, an optical drive or USB terminal. A computer program and various parameters are recorded in the recording medium 15, and by causing the reading unit 14 to read the recording medium 15, the computer program and the various parameters are stored in the nonvolatile memory of the storage unit 13.

Each ECU 20 is, for example, a device (operation system ECU) that controls various parts of the vehicle V1 (e.g., a braking device, doors, a battery, an air conditioner, etc.). The functions of the ECU 20 are not particularly limited, and the ECU 20 may be a device (cognitive system ECU) that monitors the states of various parts of the vehicle V1 by communicating with sensors.

The plurality of ECUs 20 may have different functions or may have the same functions. The number of ECUs 20 is not particularly limited. FIG. 1 shows two ECUs 20, but three or more ECUs 20 may be provided in the control system 1, or one ECU 20 may be provided therein.

The plurality of ECUs 20 include a first ECU 21 and a second ECU 22. The first ECU 21 has a transition function of causing its own operating state to transition in accordance with the power supply state of the vehicle V1. The operating state of the first ECU 21 includes, for example, a normal state, a sleep state, and a power-off state.

The normal state is a state where the first ECU 21 is waking up and the functions of the first ECU 21 that are necessary for various controls can be used. For example, the normal state is a state where a clock circuit of a processor included in the first ECU 21 is operating at a predetermined clock frequency that is set in advance.

The sleep state is a state where the functions of the first ECU 21 are more limited than in the normal state to reduce power consumption. For example, the sleep state is a state where the supply of power to the clock circuit of the processor included in the first ECU 21 is stopped to stop the operation of the clock circuit and the operation of the processor. The sleep state may be a state where power is supplied to the clock circuit of the processor included in the first ECU 21 but power consumption is reduced by causing the clock circuit to operate at a clock frequency lower than the clock frequency in the normal state.

The power-off state is a state where the functions of the first ECU 21 are more limited than in the sleep state to reduce power consumption. For example, the power-off state is a state where power is supplied only to the circuits that are minimally necessary to cause the first ECU 21 to transition to the sleep state or the normal state and the supply of power to the other circuits is stopped. The power-off state may be a state where the supply of power to all circuits included in the first ECU 21 is stopped.

The first ECU 21 transitions to the power-off state when the power supply state of the vehicle V1 is switched from another state to the vehicle power-off state. Also, the first ECU 21 transitions to the sleep state when the power supply state of the vehicle V1 is switched from another state to the ACC ON state. In addition, the first ECU 21 transitions to the normal state when the power supply state of the vehicle V1 is switched from another state to the IG ON state.

In other words, the first ECU 21 causes its operating state to transition in accordance with the power supply state of the vehicle V1 as follows.

Example of correspondence between power supply state of vehicle V1 and operating state of first ECU 21
Vehicle power-off state: power-off state
ACC ON state: sleep state
IG ON state: normal state

The above correspondence is an example, and the first ECU 21 may be in the sleep state in the vehicle power-off state, may be in the normal state in the ACC ON state, or may be in the power-off state in the ACC ON state. Also, the first ECU 21 may be in the sleep state in the IG ON state. In this case, after the first ECU 21 enters the sleep state, the first ECU 21 switches to the normal state as necessary. That is, the first ECU 21 causes its own operating state to transition between at least two of the normal state, the sleep state, and the power-off state in accordance with the power supply state of the vehicle V1.

The second ECU 22 is an ECU that does not have a transition function. That is, among the plurality of ECUs 20, the ECUs other than the first ECU 21 are all second ECUs 22.

The plurality of relay circuits 30 are connected to the plurality of ECUs 20 on a one-to-one basis. The correspondence relationship between the plurality of relay circuits 30 and the plurality of ECUs 20 is stored in the storage unit 13, for example, in a table format. Therefore, the relay control device 10 grasps which ECU 20 is connected to which relay circuit 30.

When the plurality of relay circuits 30 are particularly distinguished from each other, the relay circuit 30 connected to the first ECU 21 is referred to as “first relay circuit 31”, and the relay circuit 30 connected to the second ECU 22 is referred to as “second relay circuit 32”. Since the ECUs other than the first ECU 21 among the plurality of ECUs 20 are all second ECUs 22, the relay circuits other than the first relay circuit 31 among the plurality of relay circuits 30 are all second relay circuits 32.

Each relay circuit 30 is, for example, a mechanical relay that includes contacts and a coil and opens and closes the contacts by mechanical action. Each relay circuit 30 may be a semiconductor relay that relays by means of a semiconductor element. The semiconductor relay is, for example, a MOSFET (metal-oxide-semiconductor field-effect-transistor) relay.

The relay circuit 30 switches between a relay-on state and a relay-off state by a control signal CS1 outputted from the control unit 12 of the relay control device 10. The relay-on state is a state where the contacts are closed (or the gate of the MOSFET is turned on) and power is supplied to the ECU 20. In the example in FIG. 1, the first relay circuit 31 is in the relay-on state. The relay-off state is a state where the contacts are opened (or the gate of the MOSFET is turned off) and no power is supplied to the ECU 20. In the example in FIG. 1, the second relay circuit 32 is in the relay-off state.

When the plurality of power lines 40 are particularly distinguished from each other, the power lines 40 are referred to as power lines 41, 42, 43, and 44, respectively. Each power line 40 is a line for transmitting the power supplied from the power source device 60. The power line 41 connects the relay control device 10 and the first ECU 21 via the first relay circuit 31. The power line 42 connects the relay control device 10 and the second ECU 22 via the second relay circuit 32. That is, the relay control device 10 is directly connected to the relay circuits 30, which are provided outside the relay control device 10, by the power lines 41 and 42. The power line 43 connects the relay control device 10 and the power source device 60. The power line 44 connects the power supply control ECU 72 and the power source device 60.

When the plurality of communication lines 50 are particularly distinguished from each other, the communication lines 50 are referred to as communication lines 51, 52, 53, and 54, respectively. Each communication line 50 transmits signals transmitted and received between the devices connected by the communication line 50 in accordance with a predetermined communication protocol. The predetermined communication protocol is, for example, CAN (Controller Area Network), CAN-FD (CAN with Flexible Data Rate), or Ethernet (registered trademark).

The communication line 51 connects the relay control device 10 and the first ECU 21. The communication line 52 connects the relay control device 10 and the second ECU 22. The communication line 53 connects the relay control device 10 and the power supply control ECU 72. The communication line 54 connects the ignition switch 71 and the power supply control ECU 72.

### Problems to be Solved by the Present Embodiment

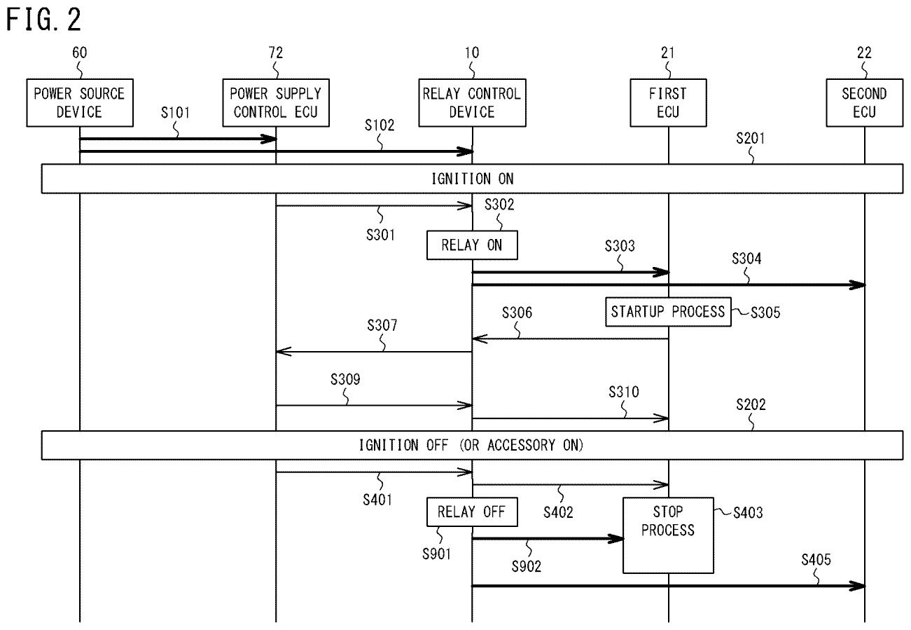

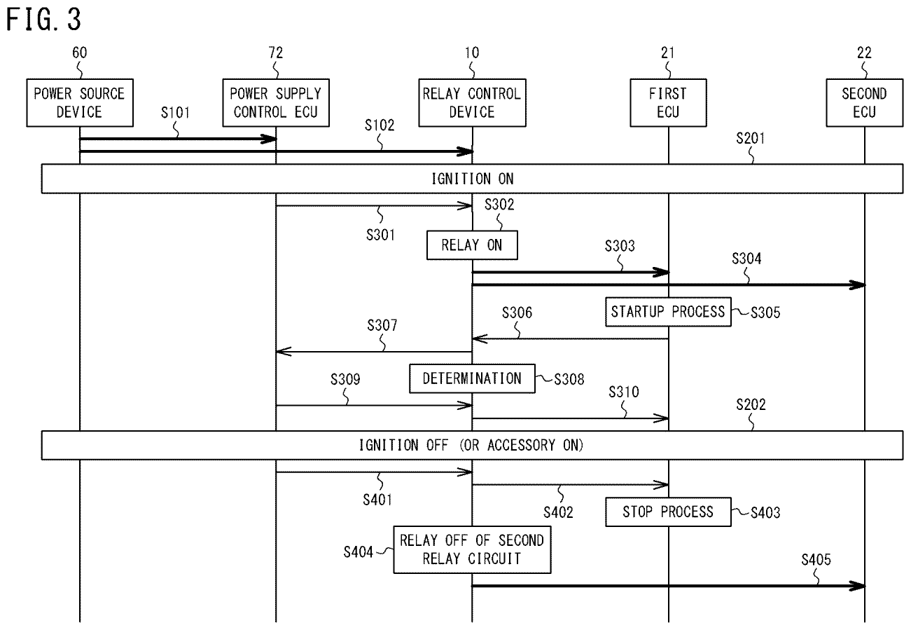

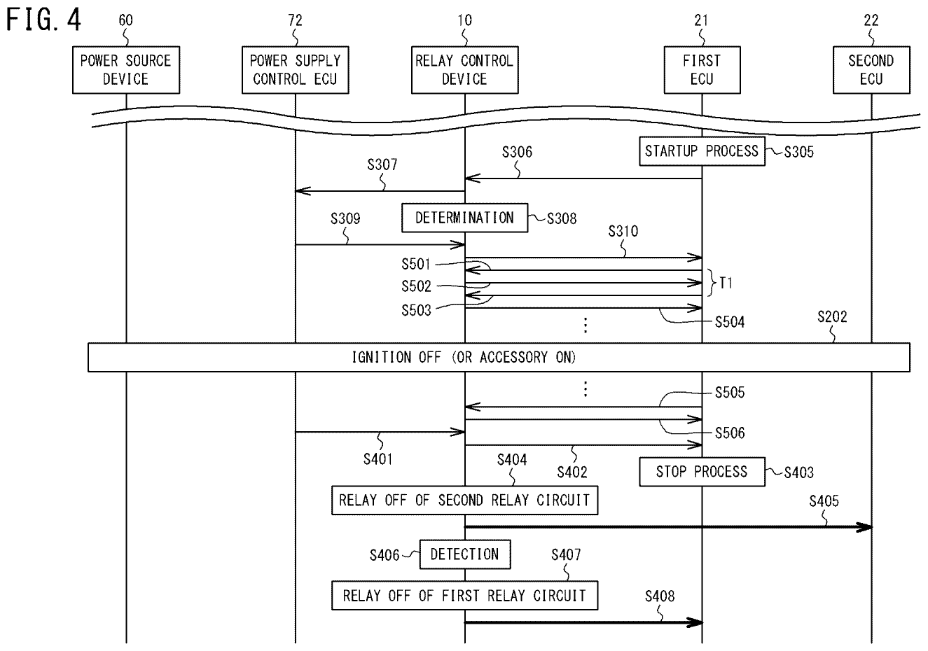

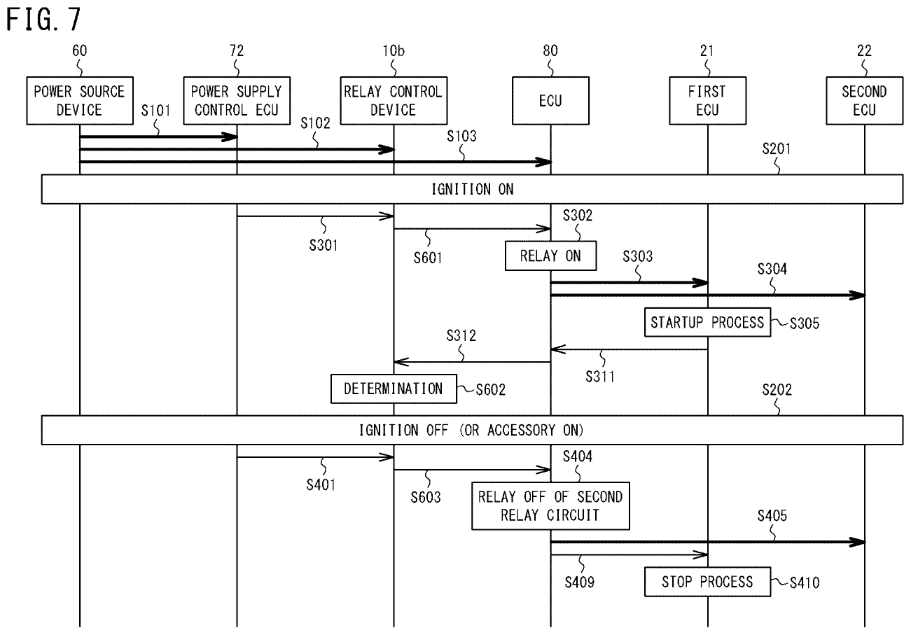

FIG. 2 illustrates a problem addressed by the embodiment. In FIG. 2, the flow showing the transmission of power is shown by thick lines, and the flow showing the transmission of signals is shown by thin lines. The same applies to subsequent flowcharts (FIG. 3, FIG. 4, and FIG. 7).

When the relay control device 10 controls the first relay circuit 31 to supply and interrupt power to the first ECU 21 (ECU 20 having a transition function), if the relay control device 10 interrupts power to the first ECU 21 while the first ECU 21 is causing its own operating state to transition, a defect may occur in the first ECU 21. This situation will be described with reference to FIG. 1 and FIG. 2.

First, the power supply state of the vehicle V1 is in the vehicle power-off state, and the plurality of relay circuits 30 are all in the relay-off state. Therefore, none of the plurality of ECUs 20 is supplied with power from the power source device 60, and the plurality of ECUs 20 are all in the power-off state.

The relay control device 10 and the power supply control ECU 72 are supplied with power from the power source device 60 via the power lines 43 and 44 regardless of the power supply state of the vehicle V1 (constant power supply: steps S101 and S102).

When the ignition switch 71 is operated and the power supply state of the vehicle V1 becomes the IG ON state (step S201), the power supply control ECU 72 transmits the power supply information D1 indicating that the power supply state of the vehicle V1 is the IG ON state, to the relay control device 10 via the communication line 53 (step S301). Step S201 may be a step in which the power supply state of the vehicle V1 is switched from the vehicle power-off state to the ACC ON state. In this case, in step S301, the power supply control ECU 72 transmits the power supply information D1 indicating that the power supply state of the vehicle V1 is the ACC ON state, to the relay control device 10 via the communication line 53.

The relay control device 10 switches each of the plurality of relay circuits 30 from the relay-off state to the relay-on state based on the power supply information D1 (step S302). Specifically, the control unit 12 outputs the control signal CS1, based on the power supply information D1. Then, each of the plurality of relay circuits 30 switches from the relay-off state to the relay-on state based on the control signal CS1. Accordingly, power is supplied to the first ECU 21 and the second ECU 22 (steps S303 and S304).

Upon receiving the supply of power, the first ECU 21 causes its operating state to transition from the power-off state to the normal state (or sleep state) (transition start process: step S305). The transition start process of the first ECU 21 in step S305 is also referred to as “startup process”.

After the startup process, the first ECU 21 transmits request information D2 for requesting the power supply control ECU 72 to notify the power supply information D1 in order to perform its own transition function (steps S306 and S307). Specifically, the request information D2 is transmitted from the first ECU 21 to the relay control device 10 via the communication line 51 (step S306) and then transmitted from the relay control device 10 to the power supply control ECU 72 via the communication line 53 (step S307).

The power supply control ECU 72 having received the request information D2 transmits the power supply information D1 to the first ECU 21 (steps S309 and S310). Specifically, the power supply information D1 is transmitted from the power supply control ECU 72 to the relay control device 10 via the communication line 53 (step S309) and then transmitted from the relay control device 10 to the first ECU 21 via the communication line 51 (step S310). The power supply control ECU 72 may periodically transmit the power supply information D1 to the first ECU 21, or may transmit the power supply information D1 to the first ECU 21 when the power supply state of the vehicle V1 is changed.

When the ignition switch 71 is operated and the power supply state of the vehicle V1 changes from the IG ON state to the vehicle power-off state (or ACC ON state) (step S202), the power supply control ECU 72 transmits the power supply information D1 indicating that the power supply state of the vehicle V1 is the vehicle power-off state (or ACC ON state), to the relay control device 10 via the communication line 53 (step S401).

The relay control device 10 transmits the received power supply information D1 to the first ECU 21 via the communication line 51 (step S402). Accordingly, the first ECU 21 causes its operating state to transition from the normal state to the power-off state (or sleep state) (transition end process: step S403). The transition end process of the first ECU 21 in step S403 is also referred to “stop process”.

If the first ECU 21 is in the sleep state at the time of start of step S403, such as if the first ECU 21 transitions to the sleep state in step S305, the first ECU 21 may cause its operating state to transition from the sleep state to the power-off state in step S403.

The relay control device 10 switches each of the plurality of relay circuits 30 from the relay-on state to the relay-off state based on the power supply information D1 (step S901). Specifically, the control unit 12 outputs the control signal CSI, based on the power supply information D1. Then, each of the plurality of relay circuits 30 switches from the relay-on state to the relay-off state based on the control signal CS1. Accordingly, the supply of power to the first ECU 21 and the second ECU 22 is interrupted (steps S902 and S405).

Here, while the first ECU 21 is executing the stop process (step S403), the first relay circuit 31 may enter the relay-off state (step S901) and the supply of power to the first ECU 21 via the power line 41 may be interrupted (step S902). When the supply of power to the first ECU 21 is interrupted, the first ECU 21 forcibly (passively) enters the power-off state.

In the stop process, for example, a process of writing the history and parameters of various processes executed by the first ECU 21 into the nonvolatile memory included in the first ECU 21, is executed. If the supply of power to the first ECU 21 is interrupted in the middle of the stop process, a defect, such as the history of the process not being stored or parameter changes not being stored, may occur.

The control system 1 is, for example, a system (extended system) that is retrofitted to a system already installed in the vehicle V1. The plurality of ECUs 20 of the control system 1 are different, depending on the contents to be extended. That is, the plurality of ECUs 20 may all be first ECUs 21, or may all be second ECUs 22.

The relay control device 10 cannot grasp at the time of connection whether the ECU 20 connected thereto is the first ECU 21 or the second ECU 22. Therefore, the relay control device 10 uniformly sets all the relay circuits 30 to the relay-off state in step S901, and as a result, the above defect may occur.

Therefore, the relay control device 10 (specifically, the control unit 12) of the present embodiment determines the first ECU 21 from among the plurality of ECUs 20 based on predetermined information (e.g., the request information D2) transmitted from the first ECU 21 to the relay control device 10. Then, instead of step S901, the relay control device 10 (control unit 12) executes switching control of switching the second relay circuit 32 to the relay-off state while maintaining the first relay circuit 31 in the relay-on state.

Accordingly, forcible interruption of the supply of power in the first ECU 21 can be avoided, so that occurrence of a defect in the first ECU 21 can be suppressed. Hereinafter, a control method in the control system 1 will be specifically described.

### Control Method

FIG. 3 is a flowchart showing an example of the control method executed by the control system 1. In the control shown in FIG. 3, control executed by the relay control device 10 is realized by the control unit 12 reading the computer program from the storage unit 13 (or according to a program written in advance in the control unit 12) and executing various calculations and processes. The order of each step shown in FIG. 3 may be changed backwards or forwards as appropriate. In the control method in FIG. 3, processes that are common to those in FIG. 2 are denoted by the same reference signs, and the description thereof is omitted as appropriate.

The control system 1 executes the same processes as in FIG. 2 until step S307. That is, after the power supply state of the vehicle V1 is changed from the vehicle power-off state to the IG ON state (step S201), the relay control device 10 brings each of the plurality of relay circuits 30 into the relay-on state based on the power supply information D1 received from the power supply control ECU 72 (step S302). Accordingly, power is supplied to the first ECU 21 and the second ECU 22 (steps S303 and S304), and the first ECU 21 executes the startup process (step S305).

After the startup process, the first ECU 21 transmits the request information D2 to the power supply control ECU 72 via the relay control device 10 in order to perform its own transition function (steps S306 and S307).

Here, the control unit 12 of the relay control device 10 determines the first ECU 21 from among the plurality of ECUs 20 based on the request information D2 received in step S306 (determination process: step S308). Since the request information D2 is information for requesting notification of the power supply information D1, it can be determined that the ECU 20 that responds to such a request is an ECU having a transition function (i.e., the first ECU 21). Therefore, when the control unit 12 receives the request information D2, the control unit 12 stores the ECU 20 that is the request source included in the request information D2, as the first ECU 21 in the storage unit 13.

Through the determination process, the control unit 12 can grasp which of the plurality of ECUs 20 is the first ECU 21. In addition, the request information D2 is information transmitted by the first ECU 21 to the power supply control ECU 72 in order to perform its own transition function. Therefore, the first ECU 21 does not need to separately generate and transmit information in order to notify the control unit 12 that the first ECU 21 has a transition function. Thus, the control load in the control system 1 can be reduced by the control unit 12 determining the first ECU 21 based on the request information D2.

In the case where the plurality of ECUs 20 include a plurality of first ECUs 21, the request information D2 is transmitted from each of the plurality of first ECUs 21 (step S306). The control unit 12 determines the plurality of first ECUs 21 from among the plurality of ECUs 20 based on a plurality of received pieces of the request information D2.

The power supply control ECU 72 having received the request information D2 transmits the power supply information D1 to the first ECU 21 (steps S309 and S310). After the power supply state of the vehicle V1 is changed from the IG ON state to the vehicle power-off state (or ACC ON state) (step S202), the relay control device 10 transmits the power supply information D1 received from the power supply control ECU 72 by step S401, to the first ECU 21 (step S402). Based on the received power supply information D1, the first ECU 21 executes the stop process (step S403).

Based on the power supply information D1 and the determination result of the determination process (step S308), the control unit 12 switches the relay circuits (i.e., the second relay circuit 32) other than the first relay circuit 31 among the plurality of relay circuits 30 to the relay-off state while maintaining the first relay circuit 31 in the relay-on state (switching control: step S404).

The control unit 12 determines the first ECU 21 from among the plurality of ECUs 20 by the determination process (step S308). The correspondence relationship between the plurality of relay circuits 30 and the plurality of ECUs 20 is stored in the storage unit 13. Therefore, the control unit 12 can determine the first relay circuit 31 and the second relay circuit 32 from among the plurality of relay circuits 30 by determining the first ECU 21.

Then, the control unit 12 switches the second relay circuit 32 to the relay-off state by outputting the control signal CSI for switching from the relay-on state to the relay-off state to the second relay circuit 32. As a result, the supply of power to the second ECU 22 is interrupted (step S405).

At this time, the control unit 12 does not output the control signal CS1 for switching from the relay-on state to the relay-off state, to the first relay circuit 31. Therefore, the control unit 12 can maintain the first relay circuit 31 in the relay-on state. As a result, the supply of power to the first ECU 21 is maintained, so that forcible interruption of the supply of power during the stop process of the first ECU 21 can be avoided. Accordingly, occurrence of a defect in the first ECU 21 can be suppressed.

### Modifications

Hereinafter, modifications of the embodiment will be described. In the modifications, the same components as those of the above embodiment are denoted by the same reference signs, and the description thereof is omitted.

### NM Communication Between ECU and Relay Control Device

In the above embodiment, the relay control device 10 maintains the first relay circuit 31 connected to the first ECU 21, in the relay-on state. However, the relay control device 10 may switch the first relay circuit 31 to the relay-off state after the stop process in the first ECU 21 is completed. Accordingly, the first ECU 21 can be electrically disconnected from the power source device 60, so that the power consumption in the control system 1 can be reduced.

A method by which the relay control device 10 determines that the stop process in the first ECU 21 has been completed is not particularly limited. For example, when the relay control device 10 and the first ECU 21 execute network management communication (hereinafter referred to as “NM communication”), the completion of the stop process in the first ECU 21 may be determined if a communication message associated with the NM communication is not received by the relay control device 10 for more than a predetermined time (i.e., if the NM communication has been stopped).

FIG. 4 is a flowchart showing a control method according to a modification. The control system 1 executes the same processes as in FIG. 3 until step S310. In FIG. 4, the processes from step S101 to step S304 are not shown.

In the example in FIG. 4, the relay control device 10 executes the NM communication with the first ECU 21. When the first ECU 21 enters the normal state as a result of the startup process (step S305), the first ECU 21 transmits a communication message M1 to the relay control device 10 via the communication line 51 at intervals of a predetermined time T1 (steps S501, S503, S505, . . . ). The communication message Ml is a message for detecting the presence or absence of communication with each other in the relay control device 10 and the first ECU 21.

The relay control device 10 transmits the communication message M1 to the first ECU 21 via the communication line 51 at a predetermined interval within the predetermined time T1 in response to (or independently of) reception of the communication message M1 from the first ECU 21 (steps S502, S504, S506, . . . ). As described above, the relay control device 10 and the first ECU 21 detect communication with each other by transmitting and receiving the communication message Ml to and from each other.

In other words, the relay control device 10 detects that the operating state of the first ECU 21 is the normal state, while receiving the communication message M1 at each predetermined interval within the predetermined time T1. In addition, the first ECU 21 detects that the operating state of the relay control device 10 is the normal state, while receiving the communication message M1 at each such predetermined interval.

After the power supply state of the vehicle V1 is changed from the IG ON state to the vehicle power-off state (or ACC ON state) (step S202), the relay control device 10 transmits the power supply information D1 to the first ECU 21 (step S402), and the first ECU 21 executes the stop process (step S403).

Through the stop process, the first ECU 21 transitions from the normal state to the sleep state (or power-off state). When the transition is completed, the first ECU 21 stops the transmission of the communication message M1 to the relay control device 10.

Based on the power supply information D1 and the determination result in step S308, the control unit 12 switches the second relay circuit 32 to the relay-off state while maintaining the first relay circuit 31 in the relay-on state (switching control: step S404). Accordingly, the supply of power to the second ECU 22 is interrupted (step S405).

The control unit 12 monitors whether or not the relay control device 10 receives the communication message Ml from the first ECU 21 at the interval within the predetermined time T1 after the switching control is executed (detection process: step S406).

If the communication message M1 is received at the interval within the predetermined time T1, this means that the first ECU 21 is in the normal state, and therefore the stop process of the first ECU 21 (step S403) is considered to be being executed. Thus, in this case, the control unit 12 maintains the first relay circuit 31 in the relay-on state. That is, if the communication message Ml is received at the interval within the predetermined time T1, the control unit 12 does not output the control signal CS1 for switching from the relay-on state to the relay-off state, to the first relay circuit 31.

If the relay control device 10 does not receive the communication message M1 for more than the predetermined time Tl after the switching control is executed, this means that the first ECU 21 is in the power-off state (or sleep state), and therefore the stop process of the first ECU 21 (step S403) is considered to be completed. Thus, in this case, the control unit 12 switches the first relay circuit 31 from the relay-on state to the relay-off state (step S407). That is, if the communication message M1 is not received for more than the predetermined time T1, the control unit 12 outputs the control signal CSI for switching from the relay-on state to the relay-off state, to the first relay circuit 31.

By step S407, the supply of power to the first ECU 21 is interrupted (step S408). The supply of power to the first ECU 21 is forcibly interrupted by the first relay circuit 31, but the stop process has already been completed, so that occurrence of a defect in the first ECU 21 can be suppressed. Accordingly, the first ECU 21 can be electrically disconnected from the power source device 60 while occurrence of a defect is suppressed, so that the power consumption in the control system 1 can be reduced.

The relay control device 10 may detect the completion of the stop process in the first ECU 21 by a method other than the NM communication. For example, when completing the stop process, the first ECU 21 may transmit a completion notification to the relay control device 10 via the communication line 51. In this case, the relay control device 10 switches the first relay circuit 31 from the relay-on state to the relay-off state based on reception of the completion notification.

### Modification of Relay Circuit

FIG. 5 shows a control system la according to a modification. In the above embodiment, each of the plurality of relay circuits 30 is provided outside the relay control device 10. In contrast, a relay circuit 30a of the present modification is provided inside a relay control device 10a included in the control system 1a.

Specifically, a plurality of relay circuits 30a are each a semiconductor relay and are each configured as a part of a circuit of the relay control device 10a. The plurality of relay circuits 30a are connected to a microcomputer 11 by a bus B1. The plurality of relay circuits 30a include a first relay circuit 31a connected to the first ECU 21 via the power line 41 and a second relay circuit 32a connected to the second ECU 22 via the power line 42.

A part or some of the plurality of relay circuits 30a may be provided inside the relay control device 10a, and the other relay circuits 30a may be provided outside the relay control device 10a. That is, in the present modification, at least one of the plurality of relay circuits 30a only needs to be provided inside the relay control device 10a.

By providing the relay circuit 30a inside the relay control device 10a, the power lines 40 of the control system la can be configured to be shorter, so that the control system la can be made compact and the power loss in the power lines 40 can be reduced.

### Switching Control Via Another Device

FIG. 6 shows a control system 1b according to a modification. In the control system 1 according to the above embodiment, the relay control device 10 is directly connected to the plurality of relay circuits 30 by the power lines 40. The control signal CS1 transmitted from the relay control device 10 is directly inputted to each of the plurality of relay circuits 30 without passing through another device (ECU or the like).

In contrast, in the control system 1b according to the modification, a relay control device 10b is connected to each of the plurality of relay circuits 30 via an ECU 80 (another device). A control signal CS2 transmitted from the relay control device 10b is relayed by the ECU 80 and then inputted to each of the plurality of relay circuits 30. Based on the control signal CS2, the ECU 80 may generate and output a new signal for controlling each of the plurality of relay circuits 30.

The relay control device 10b is, for example, an ECU (power supply control management ECU) that manages power supply control in the power source device 60. The relay control device 10b includes a microcomputer 11b including a control unit 12b and a storage unit 13b. The microcomputer 11b, the control unit 12b, and the storage unit 13b have the same configurations as the microcomputer 11, the control unit 12, and the storage unit 13 in the above embodiment, respectively. Although not shown in FIG. 6, the relay control device 10b may include a reading unit 14.

The ECU 80 is a device other than the relay control device 10b and the ECU 20 (ECU for which power supply is controlled by the relay circuit 30), and is an example of “another device” of the present disclosure. The ECU 80 may be a relay device that relays information transmitted and received between the plurality of ECUs 20. The ECU 80 is provided at the same location as the relay control device 10 in FIG. 1.

In other words, the power line 41 connects the ECU 80 and the first ECU 21 via the first relay circuit 31. The power line 42 connects the ECU 80 and the second ECU 22 via the second relay circuit 32. The power line 43 connects the ECU 80 and the power source device 60. The communication line 51 connects the ECU 80 and the first ECU 21. The communication line 52 connects the ECU 80 and the second ECU 22.

A power line 45 connects the relay control device 10b and the power source device 60. The communication line 53 connects the relay control device 10b and the power supply control ECU 72. A communication line 55 connects the relay control device 10b and the ECU 80.

The relay control device 10 of the above embodiment determines the first ECU 21 having a transition function from among the plurality of ECUs 20 based on the request information D2. In contrast, the first ECU 21 of the present modification transmits information indicating that the first ECU 21 has a transition function (hereinafter referred to as “function information D3”) as predetermined information. In this case, the first ECU 21 does not have to transmit the request information D2 requesting notification of the power supply state to the first ECU 21.

FIG. 7 is a flowchart showing a control method according to the modification. In the control shown in FIG. 7, control executed by the relay control device 10b is realized by the control unit 12b reading the computer program from the storage unit 13b (or according to a program written in advance in the control unit 12b) and executing various calculations and processes. The order of each step shown in FIG. 7 may be changed backwards or forwards as appropriate. In the control method in FIG. 7, processes that are common to those in FIG. 3 are denoted by the same reference signs, and the description thereof is omitted as appropriate.

First, the power supply state of the vehicle V1 is the vehicle power-off state, and the plurality of relay circuits 30 are all in the relay-off state. Therefore, none of the plurality of ECUs 20 is supplied with power from the power source device 60, and the plurality of ECUs 20 are all in the power-off state.

The ECU 80, the power supply control ECU 72, and the relay control device 10b are supplied with power from the power source device 60 via the power lines 43, 44, and 45 regardless of the power supply state of the vehicle V1 (constant power supply: steps S101, S102, and S103).

When the power supply state of the vehicle V1 becomes the IG ON state (step S201), the power supply control ECU 72 transmits the power supply information D1 indicating that the power supply state of the vehicle V1 is the IG ON state, to the relay control device 10b via the communication line 53 (step S301).

Based on the power supply information D1, the control unit 12b transmits the control signal CS2 for switching each of the plurality of relay circuits 30 from the relay-off state to the relay-on state, to the ECU 80 (step S601). The ECU 80 switches each of the plurality of relay circuits 30 from the relay-off state to the relay-on state based on the control signal CS2 (step S302). Accordingly, power is supplied to the first ECU 21 and the second ECU 22 (steps S303 and S304).

Upon receiving the supply of power, the first ECU 21 executes the startup process (step S305). Then, the first ECU 21 transmits the function information D3 to the relay control device 10b in order to notify the relay control device 10b that the first ECU 21 has a transition function (steps S311 and S312). Specifically, the function information D3 is transmitted from the first ECU 21 to the ECU 80 via the communication line 51 (step S311) and then transmitted from the ECU 80 to the relay control device 10b via the communication line 55 (step S312).

The function information D3 is information for exclusively indicating that the first ECU 21 has a transition function, as described above, and does not have to include, for example, information requesting transmission of other information to the first ECU 21 (e.g., the request information D2). The function information D3 may include software version information of the first ECU 21, application information regarding applications retained by the first ECU 21, or service information regarding services provided by the first ECU 21.

The control unit 12b determines the first ECU 21 from among the plurality of ECUs 20 based on the received function information D3 (determination process: step S602). Since the function information D3 is information indicating that the ECU 20 that is the transmission source has a transition function (i.e., information indicating that this ECU 20 is the first ECU 21), the control unit 12b can determine the first ECU 21 based on the function information D3. The control unit 12b stores the ECU 20 that is the transmission source included in the function information D3, as the first ECU 21 in the storage unit 13.

After the power supply state of the vehicle V1 is changed from the IG ON state to the vehicle power-off state (or ACC ON state) (step S202), the power supply control ECU 72 transmits the power supply information D1 indicating the present power supply state, to the relay control device 10b via the communication line 53 (step S401).

Based on the power supply information D1 and the result of the determination process, the relay control device 10b transmits the control signal CS2 for switching the second relay circuit 32 to the relay-off state while maintaining the first relay circuit 31 in the relay-on state, to the ECU 80 (switching control: step S603). In step S603, the relay control device 10b transmits the power supply information D1 together with the control signal CS2 to the ECU 80.

Based on the control signal CS2, the ECU 80 switches the second relay circuit 32 to the relay-off state while maintaining the first relay circuit 31 in the relay-on state (step S404). Accordingly, the supply of power to the second ECU 22 is interrupted (step S405).

The ECU 80 transmits the power supply information D1 received from the relay control device 10b, to the first ECU 21 (step S409). Based on the received power supply information D1, the first ECU 21 executes a stop process (step S410).

As described above, the relay control device 10b may be connected to the relay circuit 30 via the ECU 80 (another device). Even with such a configuration, the supply of power to the first ECU 21 is maintained, so that forcible interruption of the supply of power during the stop process of the first ECU 21 can be avoided. Accordingly, occurrence of a defect in the first ECU 21 can be suppressed.

The predetermined information transmitted by the first ECU 21 to the relay control device 10b when the first relay circuit 31 is in the relay-on state may be the request information D2, or may be the function information D3. The content and format of the predetermined information is not particularly limited as long as the predetermined information is information indicating that the first ECU 21 has a transition function.

### Modification of Determination Process

The control unit 12 according to the above embodiment determines the first ECU 21 from among the plurality of ECUs 20 in the determination process, and then determines the relay circuit 30 corresponding to the first ECU 21 as the first relay circuit 31.

However, the control unit 12 may determine the second ECU 22 (i.e., the ECU 20 other than the first ECU 21) from among the plurality of ECUs 20. The control unit 12 may also directly determine the first relay circuit 31 (or the second relay circuit 32) from among the plurality of relay circuits 30 without performing the determination of the ECU 20.

### Modification of Relay-Off Control

In step S404 of the above embodiment, all second relay circuits 32 are switched to the relay-off state. However, the control unit 12 may switch only a predetermined second relay circuit 32 to the relay-off state and maintain the other second relay circuits 32 in the relay-on state.

For example, in the case where a part of the second ECUs 22 (hereinafter referred to as “second ECU 22a”) is an ECU for accessory drive, this second ECU 22 operates in the normal state when the power supply state of the vehicle V1 is the IG ON state or ACC ON state, and enters the power-off state when the power supply state of the vehicle V1 is the vehicle power-off state. Therefore, the control unit 12 brings the second relay circuit 32 connected to the second ECU 22a into the relay-on state in the case of the IG ON state or ACC ON state, and into the relay-off state in the case of the vehicle power-off state.

In the case where the second ECU 22 other than the second ECU 22a (hereinafter referred to as “second ECU 22b”) is an ECU for ignition drive, this second ECU 22 operates in the normal state when the power supply state of the vehicle V1 is the IG ON state, and enters the power-off state when the power supply state of the vehicle V1 is the ACC ON state or vehicle power-off state. Therefore, the control unit 12 brings the second relay circuit 32 connected to the second ECU 22b into the relay-on state in the case of the IG ON state, and into the relay-off state in the case of the ACC ON state or vehicle power-off state.

In this case, for example, when a transition from the IG ON state to the ACC ON state is made in step S202 (FIG. 3), the control unit 12 switches the second relay circuit 32 connected to the second ECU 22b, to the relay-off state while maintaining the second relay circuit 32 connected to the second ECU 22a, in the relay-on state in step S404.

### Modification of Predetermined Information

In the above embodiment, the predetermined information (request information D2) is transmitted from the first ECU 21 to the relay control device 10. However, the relay control device 10 may store the predetermined information in advance (i.e., before the switching control). For example, information indicating which of the plurality of ECUs 20 is the first ECU 21 may be stored as the predetermined information in the storage unit 13. In this case, the control unit 12 performs the switching control based on the predetermined information read from the storage unit 13. The predetermined information may be stored in the storage unit 13, for example, by an operator who connects each ECU 20 to the relay control device 10 teaching whether or not each ECU 20 connected to the relay control device 10 is the first ECU 21 by using an input unit which is not shown.

### Other Modifications

The relay control device 10 of the above embodiment determines which relay circuit 30 is to be switched to the relay-off state in the control unit 12 (step S308: FIG. 3). However, the relay control device 10 may receive an instruction from another device (e.g., another ECU which is not shown) and switch a relay circuit 30 to the relay-off state based on this instruction.

For example, the relay control device 10 transmits the predetermined information to another device in step S308. Then, the other device performs a determination process, and instruction information indicating a relay circuit 30 to be switched to the relay-off state among the plurality of relay circuits 30 is transmitted from the other device to the relay control device 10. The relay control device 10 switches the second relay circuit 32 to the relay-off state based on the received instruction information in step S404. With such a configuration, the processing load in the relay control device 10 can be reduced.

### Supplementary Note

At least parts of the above embodiment and the various modifications may be combined with each other as desired. The embodiment and the modifications disclosed herein are merely illustrative in all aspects and should not be recognized as being restrictive. The scope of the present disclosure is defined by the scope of the claims, and is intended to include meaning equivalent to the scope of the claims and all modifications within the scope.

1. A relay control device installed in a vehicle, wherein the relay control device comprises a control unit configured to switch each of a plurality of relay circuits respectively connected to a plurality of ECUs, between a relay-on state where power is supplied to the ECU and a relay-off state where no power is supplied to the ECU,
the plurality of ECUs include
a first ECU having a transition function of causing its own operating state to transition between at least two of a normal state, a sleep state, and a power-off state in accordance with a power supply state of the vehicle, and
a second ECU not having the transition function, and
the control unit executes switching control of switching a second relay circuit connected to the second ECU among the plurality of relay circuits to the relay-off state while maintaining a first relay circuit connected to the first ECU among the plurality of relay circuits in the relay-on state, when switching the second ECU from the relay-on state to the relay-off state due to a change in the power supply state if each of the plurality of relay circuits is in the relay-on state.

2. The relay control device according to claim 1, wherein if the first relay circuit is in the relay-on state, the first ECU transmits predetermined information indicating that the first ECU has the transition function, to the relay control device, and
the control unit executes the switching control based on the predetermined information.

3. The relay control device according to claim 2, wherein the control unit:
maintains the first relay circuit in the relay-on state if the relay control device receives a communication message for detecting communication with the first ECU, at an interval within a predetermined time after the switching control is executed; and
switches the first relay circuit to the relay-off state if the relay control device does not revive the communication message for more than the predetermined time after the switching control is executed.

4. The relay control device according to claim 2, wherein the predetermined information includes information requesting notification of the power supply state to the first ECU.

5. The relay control device according to claim 2, wherein, based on the predetermined information, the control unit
determines the first ECU from among the plurality of ECUs or
determines the first relay circuit from among the plurality of relay circuits.

6. The relay control device according to claim 2 being connected to a relay circuit provided outside the relay control device among the plurality of relay circuits, directly by a power line, or via another device.

7. The relay control device according to claim 2, wherein at least one of the plurality of relay circuits is provided inside the relay control device.

8. A control system comprising:
the relay control device according to claim 2;
a plurality of the ECUs including the first ECU; and
a plurality of the relay circuits including the first relay circuit.

9. A control method for controlling a plurality of relay circuits respectively connected to a plurality of ECUs, by a relay control device installed in a vehicle, wherein the plurality of ECUs include
a first ECU having a transition function of causing its own operating state to transition between at least two of a normal state, a sleep state, and a power-off state in accordance with a power supply state of the vehicle, and
a second ECU not having the transition function,
the control method comprises a switching step of switching each of the plurality of relay circuits between a relay-on state where power is supplied to the ECU and a relay-off state where no power is supplied to the ECU, and
the switching step includes a step of switching a second relay circuit connected to the second ECU among the plurality of relay circuits to the relay-off state while maintaining a first relay circuit connected to the first ECU among the plurality of relay circuits in the relay-on state, when switching the second ECU from the relay-on state to the relay-off state due to a change in the power supply state if each of the plurality of relay circuits is in the relay-on state.

10. A computer program for controlling a plurality of relay circuits respectively connected to a plurality of ECUs, by a relay control device installed in a vehicle, wherein the plurality of ECUs include
a first ECU having a transition function of causing its own operating state to transition between at least two of a normal state, a sleep state, and a power-off state in accordance with a power supply state of the vehicle, and
a second ECU not including the transition function,
the computer program causes a computer to execute a switching step of switching each of the plurality of relay circuits between a relay-on state where power is supplied to the ECU and a relay-off state where no power is supplied to the ECU, and
the switching step includes a step of switching a second relay circuit connected to the second ECU among the plurality of relay circuits to the relay-off state while maintaining a first relay circuit connected to the first ECU among the plurality of relay circuits in the relay-on state, when switching the second ECU from the relay-on state to the relay-off state due to a change in the power supply state if each of the plurality of relay circuits is in the relay-on state.

11. The relay control device according to claim 3, wherein the predetermined information includes information requesting notification of the power supply state to the first ECU.

12. The relay control device according to claim 3, wherein, based on the predetermined information, the control unit
determines the first ECU from among the plurality of ECUs or
determines the first relay circuit from among the plurality of relay circuits.

13. The relay control device according to claim 3 being connected to a relay circuit provided outside the relay control device among the plurality of relay circuits, directly by a power line, or via another device.

14. The relay control device according to claim 3, wherein at least one of the plurality of relay circuits is provided inside the relay control device.

15. A control system comprising:
the relay control device according to claim 3;
a plurality of the ECUs including the first ECU; and
a plurality of the relay circuits including the first relay circuit.
